(19) United States
(12) Patent Application Publication
(10) Pub. No.: US 2018/0086383 A1
(43) Pub. Date: Mar. 29, 2018

(54) OUTRIGGER

(71) Applicant: LIPPERT COMPONENTS, INC., Elkhart, IN (US)

(72) Inventors: Trenton MILLER, Goshen, IN (US); Kaleb VANORT, Granger, IN (US)

(21) Appl. No.: 15/719,859

(22) Filed: Sep. 29, 2017

Related U.S. Application Data
(60) Provisional application No. 62/401,547, filed on Sep. 29, 2016.

(51) Int. Cl. B62D 21/03; B62D 29/04

(52) U.S. Cl. CPC B62D 21/03; B62D 29/041

(57) ABSTRACT

An outrigger includes a web, an upper flange extending transversely from an upper edge of the web, a lower flange extending transversely from a lower edge of the web, and a mounting flange extending transversely from a first end of the web, a first end of the upper flange, and a first end of the lower flange. The web includes first, second, and third portions, neither of which is co-planar with any other of which.

### CROSS-REFERENCE TO RELATED APPLICATION

This application claims benefit of U.S. Provisional Patent Application No. 62/401,547, filed on Sep. 29, 2017, and incorporates by reference the disclosure thereof in its entirety.

### BACKGROUND AND SUMMARY OF THE DISCLOSURE

A vehicle, for example, a recreational vehicle or trailer, may include a body mounted on a frame. The frame may include two or more frame rails oriented longitudinally (that is, in the direction of travel of the vehicle) and two or more crossbeams oriented laterally or crosswise (that is, perpendicular to the direction of travel of the vehicle) and connecting the rails together. One or more axles and wheels may be attached to the frame directly or through an intervening suspension system, with the wheels outboard of the frame rails. Significant portions of the body may extend laterally a substantial distance outwardly beyond the frame rails.

Structural support for the portions of the body extending outwardly beyond the frame rails may be provided by outwardly-extending outriggers attached to the outboard sides of the frame rails. Such outriggers typically are made of steel or other metals. They may be stamped or forged from a single piece of material, or they may be embodied as weldments assembled from two or more pieces of material. The final form of such outriggers may be dictated by limitations of the materials and processes used to fabricate the outriggers.

### BRIEF DESCRIPTION OF THE DRAWINGS

FIG. 1 is an end view of a longitudinal frame rail of a vehicle with an outrigger attached thereto according to the present disclosure;

FIG. 2 is an outboard perspective view of the longitudinal frame rail and outrigger of FIG. 1;

FIG. 3 is another outboard perspective view of the longitudinal frame rail and outrigger of FIG. 1;

FIG. 4 is an inboard perspective view of a longitudinal frame rail and outrigger attached thereto;

FIG. 5 is a perspective view of the outrigger of FIG. 1;

FIG. 6 is a top plan view of the outrigger of FIG. 5;

FIG. 7 is a front elevation view of the outrigger of FIG. 5;

FIG. 8 is a bottom plan view of the outrigger of FIG. 5;

FIG. 9 is a first end elevation view of the outrigger of FIG. 5; and

FIG. 10 is a second end elevation view of the outrigger of FIG. 5.

### DETAILED DESCRIPTION OF THE DRAWINGS

Terms of orientation, for example, upper, lower, vertical, and horizontal, used herein should be construed as referring to relative, rather than absolute, orientation, unless context clearly dictates otherwise.

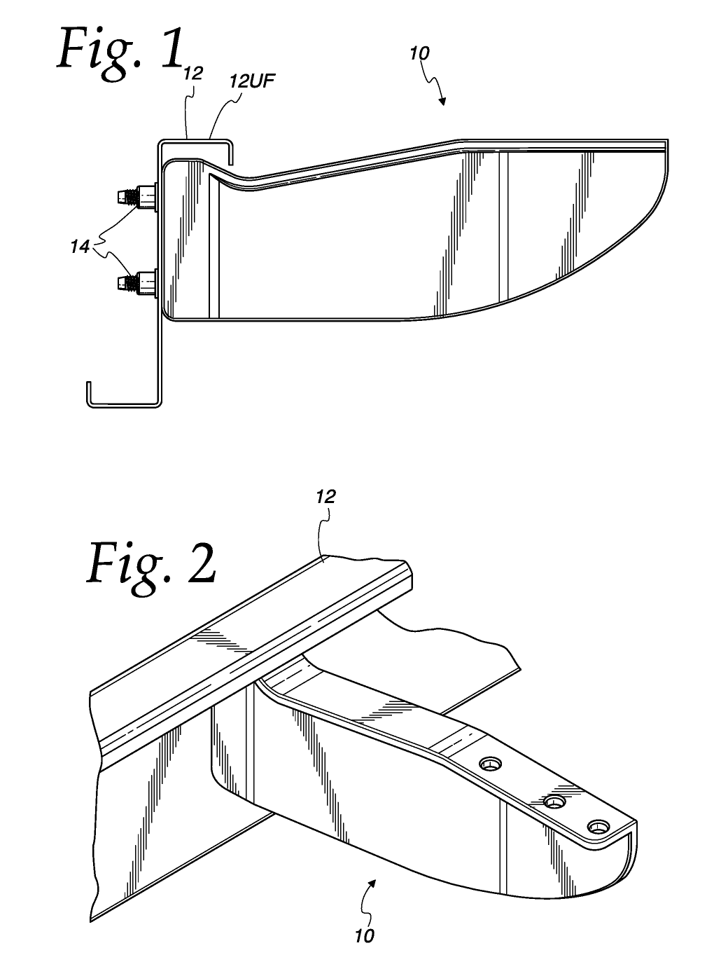

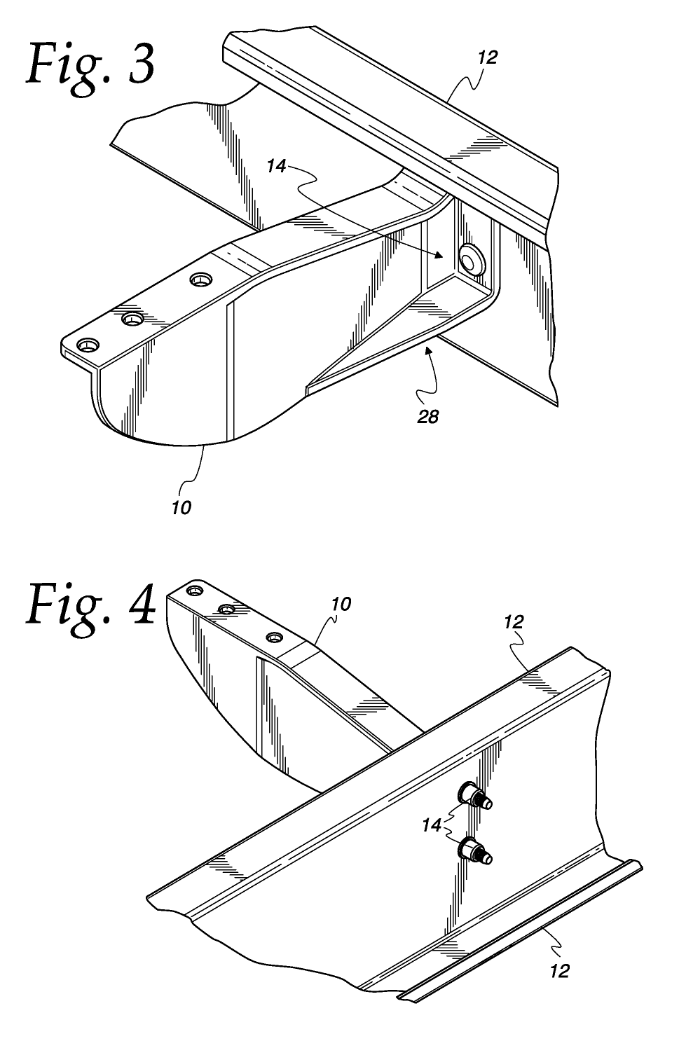

FIGS. 1-4 show an illustrative outrigger 10 attached to a longitudinal frame rail 12 of a frame of a vehicle according to the present disclosure. As best shown in FIGS. 3 and 4, the outrigger 10 may be attached to an outboard side of the frame rail 12 using one or more mechanical fasteners 14, for example, threaded fasteners, rivets, huck bolts, or the like, extending through corresponding apertures in the frame rail and the outrigger.

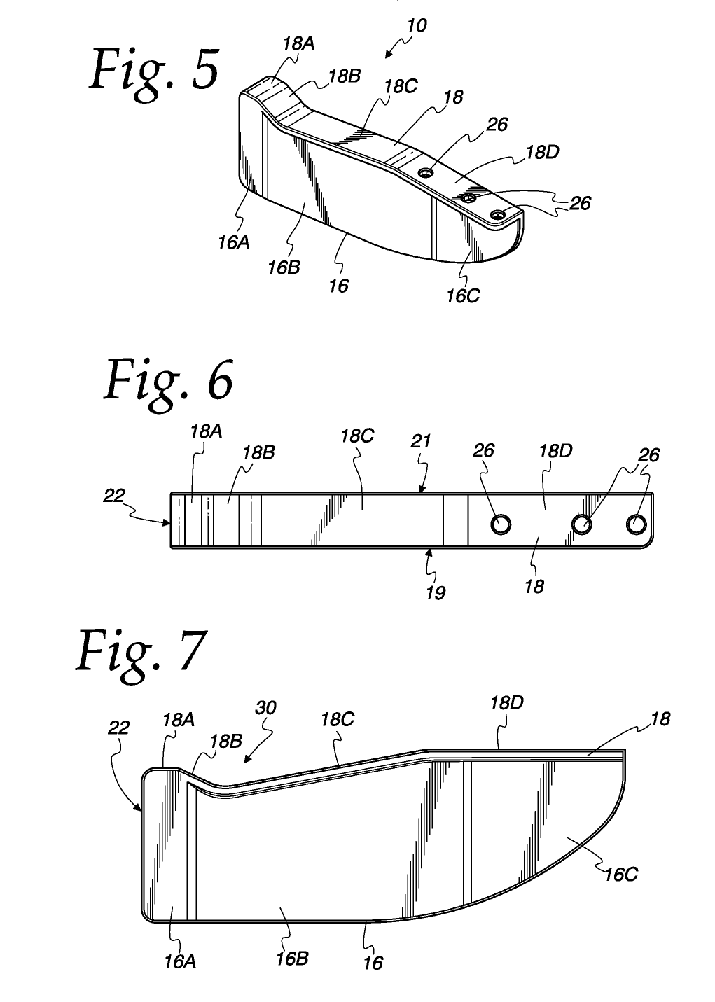

FIGS. 5-10 show the outrigger 10 in isolation. The outrigger 10 includes a generally vertical web 16 having a first end, a second end, an upper edge, and a lower edge. An upper flange 18 having a first end, a second end, a first side, and a second side is attached transversely to the upper edge of the web 16. A lower flange 20 having a first end, a second end, a first side and a second side is attached transversely to the lower edge of the web 16. A generally vertical mounting flange 22 is attached transversely to each of the first end of the web 16, to the first end of the upper flange 18, and to the first end of the lower flange 20.

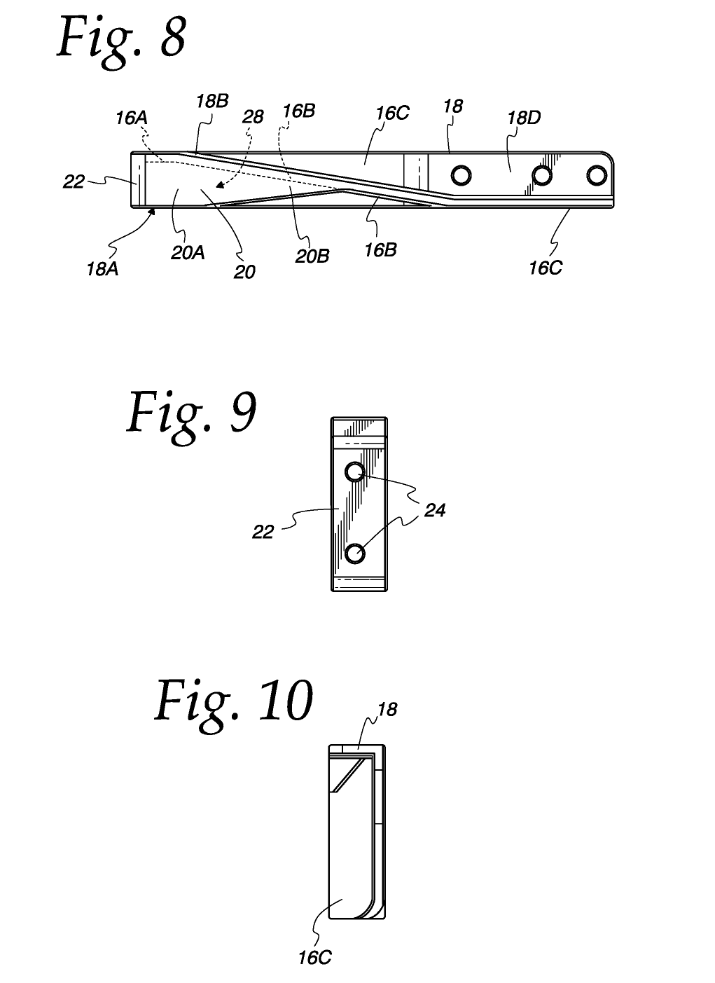

The web 16 includes a first portion 16A, a second portion 16B, and a third portion 16C, with the second portion extending between an end of the first portion and an end of the third portion. As best shown in FIG. 8, none of the first portion 16A, the second portion 16B, and the third portion 16C is co-planar with any other of the first portion, the second portion, and the third portion. As shown, the first portion 16A and the third portion 16C are generally, planar, parallel to, and offset from each other, and the second portion 16B is generally planar and connected between opposing ends of the first portion and the second portion. In other embodiments, any one or more of the first portion 16A, the second portion 16B, and the third portion 16C could be curved about a vertical, horizontal, or other axis, compound curved (curved about more than one of a vertical, horizontal, and other axis), or could have a combination of curved and planar portions. The interfaces between adjacent portions 16A-16C of the web could be continuous (for example, curved) or discontinuous (as shown).

The upper edge of the web 16 is shown as being contoured to complement the shape of the upper flange 18, as will be discussed further below. As best shown in FIG. 7, the lower edge of the web 16 includes a generally linear portion extending generally horizontally from the first end of the web (the end proximate the mounting flange 22) to about midway between the first end and the second end of the web (that is, about the midpoint of the web), and a curved portion extending from the end of the linear portion of the lower edge of the web to the second end of the web. The lower edge of the web 16 is oriented vertically or nearly vertically proximate the second end of the web. As shown, the radius of curvature of the curved portion of the lower edge of the web 16 may vary from relatively large proximate the midpoint of the web and relatively small proximate the second end of the web. The linear portion of the lower edge of the web 16 is generally coextensive with the first portion 16A and part of the second portion 16B. The curved portion of the lower edge of the web 16 is generally coextensive with another part of the second portion 16B and the third portion 16C of the web 16.

As shown, the upper flange 18 includes a first portion 18A coextensive with the first portion 16A of the web 16, a second portion 18B coextensive with part of the first portion 16A of the web and part of the second portion 16B of the web, a third portion 18C coextensive with another part of the second portion 16B of the web, and a fourth portion 18D coextensive with a further part of the second portion 16B of the web and with the third portion 16C of the web. The upper flange 18 also includes respective transition regions between adjacent portions 18A-18D thereof. More specifically, the upper flange 18 includes a first transition region between the first portion 18A and the second portion 18B thereof, a second transition region between the second portion 18B and the third portion 18C thereof, and a third transition region between the third portion 18C and the fourth portion 18D thereof.

The upper flange 18 defines a first edge 19 and a second edge 21. The first edge 19 and the second edge 21 are parallel to each other, to the first section of the web 16, and to the third section of the web.

Each portion 18A-18D of the upper flange 18 is shown as being generally planar, and the transition regions between adjacent portions 18A-18D of the upper flange 18 are shown as being generally curved and continuous. As shown, the first portion 18A and fourth portion 18D of the upper flange 18 are generally horizontal, with the fourth portion defining a plane vertically and upwardly offset from a plane defined by the first portion. The second portion 18B angles downward from the first portion 18A, and the third portion 18C angles downward from the fourth portion 18D. As such, the second portion 18B and the third portion 18C cooperate to define a trough 30. As best shown in FIG. 1, the foregoing configuration of the upper flange 18 facilitates assembly of the outrigger 10 to a web of a frame rail 12 in a manner that allows a portion of the upper flange, for example, the fourth portion 18D of the upper flange, to be substantially coplanar or otherwise of substantially even height with an upper flange 12UF of the frame rail 12.

As suggested above, the upper edge of the web 16 is shown as conforming to the shape of the upper flange 18 and attached continuously thereto. In other embodiments, the upper flange 18 could be attached discontinuously to the web 16. In further embodiments, the upper flange 18 could have other configurations, and the upper edge of the web 16 and the upper flange 18 could conform continuously or discontinuously to each other and be attached continuously or discontinuously to each other.

Further, the upper flange 18 is shown as having a substantially continuous width from the first end to the second end thereof (although a corner of the upper flange proximate the second end thereof is shown as being radiused).

The upper flange 18 may define one or more apertures 26 configured to receive mechanical fasteners that may be used to attach another component (not shown), for example, a board or panel, to the outrigger 10.

The mounting flange 22 is shown as generally rectangular and extending transversely from the first end of the web 16, the first end of the upper flange 18, and the first end of the lower flange 20. As such, as best shown in FIGS. 3 and 8, the web 16, the upper flange 18, the lower flange 20, and the mounting flange 22 cooperate to define a pocket 28. The mounting flange 22 is shown as being attached at its upper and lower ends, respectively, to the upper flange 18 and to the lower flange 20 via first and second, intervening, radiused corners. As shown, the mounting flange 22 may define one or more apertures 24 configured to receive fasteners 14 for attaching the outrigger 10 to a frame rail 12 or other structure. As best shown in FIG. 9, the apertures 24 may be closer to one side edge of the mounting flange 24 than to the other side edge.

As best shown in FIGS. 3 and 8, the lower flange 20 extends transversely from the lower edge of the web 16 and transversely from the lower end of the mounting flange 22. The lower flange 20 includes a first, rectangular portion 20A proximate the first end thereof adjacent the mounting flange 22. The lower flange 20 also includes a second portion 20B that tapers to a point proximate the second end thereof.

The outrigger 10 may be made of any suitable material. In some embodiments, the outrigger 10 could be made of a polymeric material, for example, fiber reinforced nylon or another a plastic material. In such embodiments, the outrigger 10 could be monolithically or otherwise formed by any suitable process, for example, injection molding.

In other embodiments, the outrigger 10 could be made of metal. For example, the outrigger 10 could be made in one piece by die-casting zinc alloy or aluminum alloy. As another example, the outrigger 10 could be made of steel or a steel alloy in one or more pieces using one or more of casting, machining, and welding processes.

As discussed above, the outrigger 10 may be attached to a frame of a vehicle. So attached, the outrigger 10 may provide support for a floor or other component of the vehicle. In applications wherein the outrigger 10 is used, for example, as a floor support, the trough 30 may provide sufficient clearance between the outrigger and the frame rail to which it may be attached and/or between the outrigger and the floor to enable routing of pipes, conduits, hoses, cables, or other elements therebetween.

The embodiments disclosed herein are illustrative and should not be deemed to limit the scope of the appended claims.

1. An outrigger comprising:
a web having a first section, a second section, and a third section, the second section connected between the first section and the third section, wherein none of the first section, the second section, and the third section is coplanar with any other of the first section, the second and the third section;
an upper flange extending from an upper portion of the web
a lower flange extending from a lower portion of the web; and
a mounting flange connected to a first end of the upper flange, a first end of the lower flange, and a first end of the web.

2. The outrigger of claim 1, one of the upper flange and the lower flange extending transversely from the respective upper portion and lower portion of the web.

3. The outrigger of claim 2, the other of the upper flange and the lower flange extending transversely from the respective upper portion and lower portion of the web.

4. The outrigger of claim 1,
wherein the upper flange includes a first portion connected to and substantially perpendicular to the mounting flange, a second portion connected to the first portion opposite the mounting flange, a third portion connected to the second portion opposite the first portion and a fourth portion connected to the third portion opposite the second portion, the fourth portion substantially parallel to the first portion; and
wherein the upper flange has a first edge and a second edge, the second edge substantially parallel to the first edge, the first section of the web and the third section of the web.

5. The outrigger of claim 4, the first portion and the second portion of the upper flange coextensive with the first section of the web, the third portion of the upper flange coextensive with the second section of the web, and the fourth portion of the upper flange coextensive with the second section and the third section of the web.

6. The outrigger of claim 4 wherein the upper flange defines a trough.

7. The outrigger of claim 1 wherein the upper flange defines a substantially continuous upper surface.

8. The outrigger of claim 1, the lower flange coextensive with the first and second sections of the web.

9. The outrigger of claim 1, wherein the second section of the web is substantially planar.

10. The outrigger of claim 1, wherein the second section of the web is curvilinear.

11. The outrigger of claim 1, the mounting flange defining at least one aperture.

12. The outrigger of claim 1, the upper flange defining at least one aperture.

13. The outrigger of claim 1 in combination with a member of a frame, the outrigger connected to the member of a frame.

14. The outrigger of claim 1 wherein the web comprises a lower edge, the lower edge having a linear portion extending from the mounting flange and a curvilinear portion extending from the linear portion.

15. The outrigger of claim 14 wherein the linear portion extends substantially perpendicularly from the mounting portion.

16. The outrigger of claim 1 formed monolithically.

17. The outrigger of claim 1 formed monolithically of a plastic material.
